(19) United States
(12) Patent Application Publication
(10) Pub. No.: US 2024/0070612 A1
(43) Pub. Date: Feb. 29, 2024

(54) SYSTEM AND METHOD FOR INVENTORYING, DISPLAYING, MONITORING, AND SELECTION OF FAUNA ITEMS

(71) Applicant: Pafe Plants LLC, Manhattan, NY (US)

(72) Inventor: Calvin Li, Manhattan, NY (US)

(21) Appl. No.: 18/239,995

(22) Filed: Aug. 30, 2023

Related U.S. Application Data
(60) Provisional application No. 63/402,235, filed on Aug. 30, 2022.

(51) Int. Cl. G06Q 10/087; G06T 19/00; G06V 20/52

(52) U.S. Cl. CPC G06Q 10/087; G06T 19/006; G06V 20/52

(57) ABSTRACT

Described is a system for inventorying, displaying, monitoring, and selection of fauna items over a communications network. The system includes a conveying system for moving a fauna item from one area to another and attaching a unique identifier to the fauna item. A recording system includes cameras for capturing visual content of the fauna item from multiple perspectives, including an image of the unique identifier. A fauna item record is created in a database for each fauna item which includes the image of the unique identifier and the visual content for the fauna item. Webpage data, which includes the visual content for the fauna item and the image of the unique identifier, is sent to and displayed on consumer devices.

### CROSS-REFERENCE TO RELATED APPLICATIONS

This application claims the benefit of the filing date of U.S. Provisional Patent Application Ser. No. 63/402,235 titled “SYSTEM AND METHOD FOR INVENTORYING, DISPLAYING, MONITORING, AND SELECTION OF FAUNA ITEMS” and filed Aug. 30, 2022; and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to a system and method for conducting horticultural business via a communications network, and more specifically to a system and method for inventorying, displaying, selecting, and delivering horticultural products via a communications network.

### BACKGROUND

Recently, buying and caring for fauna items, including indoor plants, has become increasingly popular. Indoor plants, also referred to as houseplants, are generally easy to care for and provide a natural, decorative element to indoor spaces. Multiple online platforms exist which allow consumers to view and purchase indoor plants of different types and sizes and have them delivered directly to their homes or offices.

While there are companies that allow a consumer to select a specific type of plant based on the physical characteristics of the plant displayed on the online platform (e.g., webpage), there is no guarantee that the plant that is displayed on the webpage is identical in size, shape, and color to the one that will be delivered to the consumer. In fact, some websites include a disclaimer that the actual product may differ slightly from images online. With regards to houseplants, it can be important to a consumer that the houseplant ordered is of a specific size and shape to properly fit in a desired location in their home.

As a result, there exists a need for improvements over the prior art and, more particularly, for a system and method for conducting horticultural business that allows a consumer to identify, select, and purchase the specific plant displayed on an online platform for their indoor space.

### SUMMARY

A system and method for inventorying, displaying, monitoring and selection of a plurality of fauna items is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for inventorying, displaying, monitoring and selection of a plurality of fauna items over a communications network is disclosed. The system comprises a conveying system for moving a respective fauna item from a first area to a second area. The conveying system is configured for attaching a unique identifier proximate to the respective fauna item at the first area. A recording system is positioned at the second area. The recording system includes a plurality of cameras arranged for capturing images or visual content of the respective fauna item from a plurality of perspectives. The system further comprises a database in connection with a processor, and the processor is configured to perform multiple operations. The processor is configured to receive a first sensor signal from a first sensor indicating that the respective fauna item is within a predetermined proximity of the first area. After receiving the first sensor signal, the processor is further configured to send a conveyance signal to the conveying device causing the conveying device to move the respective fauna item from the first area to the second area. The processor receives a second sensor signal from a second sensor that the respective fauna item is in the second area. The processor then sends a recording signal to the recording system to activate the recording system to capture visual content of the respective fauna item from the plurality of perspectives, including an image of the unique identifier. The processor is further configured to create, in the connected database, a fauna item record for each of the plurality of fauna items. The processor stores, in each respective fauna item record, the image of the unique identifier for the respective fauna item, the visual content for the respective fauna item, and other data associated with the respective fauna item. Webpage data to display on a webpage on consumer computing devices of consumer is sent, over the communications network, to a transceiver of a plurality of consumer devices. The webpage data includes data for displaying the image of the unique identifier for the respective fauna item, the visual content for the fauna item, and other data associated with the respective fauna item.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is an illustration of an operating environment that supports a system for conducting horticultural business via a communications network, according to an example embodiment;

FIG. 2 is an illustration of system components of a system for conducting horticultural business via a communications network, according to an example embodiment;

FIG. 3 is a flow diagram illustrating a method for inventorying and displaying fauna items, according to an example embodiment;

FIG. 4A is an illustration of a graphical user interface for conducting horticultural business via a communications network, according to an example embodiment;

FIG. 4B is an illustration of a graphic user interface for conducting horticultural business via a communications network, according to an example embodiment;

FIG. 4C is an illustration of a graphical user interface for conducting horticultural business via a communications network, according to an example embodiment;

FIG. 4D is an illustration of a graphical user interface for conducting horticultural business via a communications network, according to an example embodiment;

FIG. 4E is an illustration of a graphical user interface for conducting horticultural business via a communications network, according to an example embodiment;

FIG. 4F is an illustration of a graphical user interface for conducting horticultural business via a communications network, according to an example embodiment;

FIGS. 5 through 5A are a flow diagram illustrating a method for inventorying and displaying fauna items, according to another example embodiment;

FIG. 6 is a flow diagram illustrating a method for selection and order fulfillment of a fauna item, according to an example embodiment; and

FIG. 7 is an illustration of a computer system for conducting horticultural business via a communications network, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments provide a system and method for inventorying, displaying, monitoring and selection of a plurality of fauna items over a communications network. The system and method provide a conveying system for attaching a unique identifier to a fauna item in one area and moving the fauna item to a second area with a recording system. The recording system captures visual content (e.g., images) of the fauna item from multiple perspectives, including an image of the unique identifier assigned to the fauna item. A record of the visual content of the fauna item, other data associated with the fauna item (e.g., detailed description, cost), and the unique identifier are stored in a database, which is accessible via a webpage displayed on a consumer device. In one embodiment, the system and method improve over the prior art by providing actual images of the fauna items displayed on the consumer device instead of stock photos or generic images, such that a consumer can view exact images of the fauna items before placing an order. Actual images provide a clear and accurate representation of the fauna item thereby reducing possibility of mismatch of the fauna item ordered and received by the consumer which builds trust with the seller and enhances consumer satisfaction. In one embodiment, the system and method improve over the prior art by providing high quality images from different perspectives of the same fauna item. The consumer is more likely to purchase items when they see high-quality images of the fauna item from different angles. Such a visual confirmation increases their confidence in the fauna item's quality and condition. Consumers have better understanding of what they are buying, that reduces the likelihood of returns due to misaligned expectations or dissatisfaction with the fauna item's appearance. In one embodiment, the system and method improve over the prior art by providing an augmented reality system that allows the consumers to visualize the fauna item in their home or office. Such an augmented reality system allows the consumers to see how the item would look in their real-world environment. The consumers may rotate, zoom in, and interact with these virtual models, gaining a better understanding of the fauna item's features, design, and size. Thus, the system and method described herein improves horticultural business practices by allowing a consumer to identify, select, and purchase the specific plant, as identified by the unique identifier, displayed on the webpage for their home.

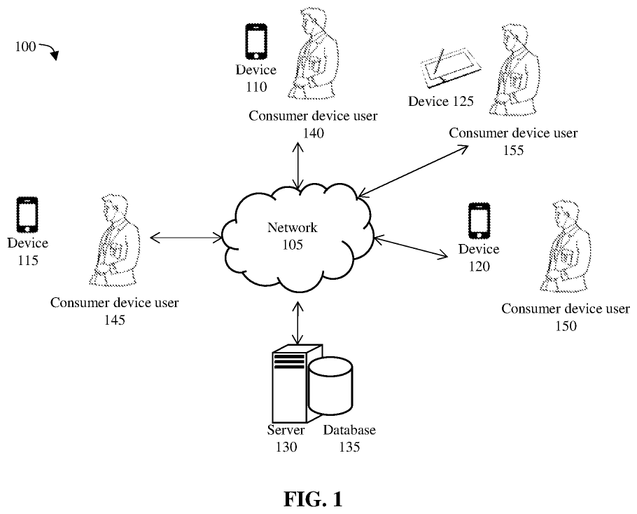

Referring now to the Figures, FIG. 1 is a diagram of an operating environment or system 100 that supports a computer application and system for inventorying, displaying, monitoring and selection of a plurality of fauna items over a communications network 105. The system 100 comprises consumer devices, including mobile devices 110, 115, 120, and device 125, all of which may communicate with server 130 via the communications network 105. Mobile devices 110, 115, 120 and device 120 may comprise any computing devices, such as integrated circuits, printed circuit boards, processors, ASICs, PCBs, cellular telephones, smart phones, tablet computers, laptops, desktop computers, and game consoles, for example. Mobile devices 110, 115, 120, and device 125 may be connected wirelessly to the communications network 105. Communications network 105 may include one or more packet switched networks, such as the Internet, or any local area networks, wide area networks, enterprise private networks, cellular networks, phone networks, mobile communications networks, or any combination of the above. In one embodiment, mobile devices 110, 115, 120, and device 125 are a programmable logic controller or PLC.

Server 130 includes a software engine that delivers applications, data, program code and other information to networked devices 110, 115, 120, and 125. The software engine of server 130 may perform other processes such as transferring multimedia data in a stream of packets that are interpreted and rendered by a software application as the packets arrive. FIG. 1 further shows that server 130 includes a database 135 or repository, which may be a relational database comprising a Structured Query Language (SQL) database stored in a SQL server or a database that adheres to the NoSQL paradigm. Devices 110, 115, 120, and 125 may also each include databases.

The database 135 may store sensor data, as well as related information, used by server 130 and devices 110, 115, 120, and 125 during the course of operation of the invention by consumer device users 140, 145, 150, and 155. For example, such devices may include one or more sensors (e.g., camera) for capturing images via devices 110, 115, 120, and 125 and/or connecting over the communications network 105 during the course of operation of the invention. Such sensors may comprise technology such as a wireless communication element, such as WIFI, Bluetooth, NFC etc. In one embodiment, the data provided by devices 110, 115, 120, and 125 is provided to server 130 via TCP/IP and/or HTTP over communications network 105.

Devices 110, 115, 120, and 125 and server 130 may each include program logic comprising computer source code, scripting language code or interpreted language code that perform various functions of the present invention. It should be noted that although FIG. 1 shows only four devices 110, 115, 120, and 125 and server 130, the system of the present invention supports any number of computing devices, servers and client computing devices connected via communications network 105. Also note that although server 130 is shown as a single and independent entity, in one embodiment, server 130 and its functionality can be realized in a centralized fashion in one computer system or in a distributed fashion wherein different elements are spread across several interconnected computer systems.

Various types of data may be stored in the database 135 of server 130. For example, the database 135 may be configured to store consumer data of each consumer in a consumer record. In one embodiment, the user data may include a username, email address, and shipping address. The database 135 may be further configured to store all data related to fauna items and containers for fauna items. In one embodiment, data related to the fauna items may include images of fauna items, type of fauna items, origin and natural habitat of the fauna items, required soil conditions, frequency of watering and dimensions of the fauna items. Data related to the containers may include shape, size, color, material of the container, and weight of the container.

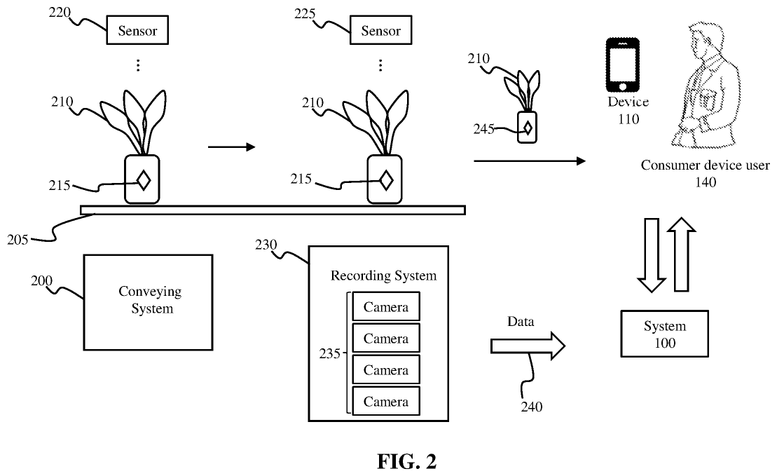

FIG. 2 depicts the components of the system for conducting horticultural business via a communications network, which includes inventorying, displaying, monitoring, and selection of fauna items. As described above, the invention described herein provides a system and method which allows a consumer to identify, select, and purchase a specific plant, or fauna item. Fauna items, such as plants, trees, shrubs, flowers, bushes, or any combination thereof, are housed in a warehouse, storage facility, or any suitable building having a plurality of areas that include the proper light conditions, temperature conditions, and space for maintaining the fauna items. The warehouse may be equipped with climate control systems to regulate temperature and humidity as different plant species have varying requirements. The warehouse may also have climate monitoring systems installed to monitor that the environment remains within the optimal range for plant storage. Such warehouse may have specialized shelving or racking systems to maximize space while allowing for proper ventilation and organization. The fauna items are stored on shelves or racks with adequate spacing to prevent overcrowding and damage to leaves or branches of the fauna items. Depending on specific requirements of a plant variety, the warehouse may have automated irrigation systems in place to maintain consistent moisture levels. For example, drip irrigation or misting systems may be used to keep the fauna items hydrated.

As shown in FIG. 2, a conveying system 200 is positioned within the building for conveying (i.e., transporting) fauna items 210 from a first area to a second area. The fauna items 210 are received at the first area in the warehouse. Receiving the fauna items 210 at the first area in the warehouse is an essential process in inventory management that involves physical intake and recording of the fauna items 210 as they arrive at the warehouse from suppliers, or other sources. Properly managing this process is essential for maintaining accurate inventory records, ensuring stock availability, and facilitating efficient order fulfillment. In an example, the first area may be a designated receiving dock or an area where incoming shipments and fauna items 210 are received and inspected. For example, the first area may be equipped with necessary tools, equipment, and personnel to handle the unloading and initial assessment of incoming goods. The fauna items 210 may be monitored for any visible damage or signs of tampering to identify potential issues before accepting the fauna items 210 into the warehouse. In an embodiment, depending on a type of a fauna item 210, a quality control check is performed to verify if the received items meet the expected quality standards. The received items are also monitored for any defect and damage when stored in the warehouse. For example, the fauna item 210 may be monitored for decay or damage of a shrub or a flower or a tree when the fauna item 210 is stored over a period of time in the warehouse. The warehouse may be equipped with a camera or set of cameras arranged around a shelf or a rack, where the fauna item 210 is placed, to capture images of the fauna item 210 for monitoring damage or decay of the fauna item 210. Any damaged or defective items may be flagged for return or replacement. It is understood that the term “a fauna item 210” refers to one fauna item from a group of “fauna items 210”, and are used interchangeably throughout this application.

The conveying system 200 may include a conveying device 205 that is configured for mechanically moving a fauna item 210 from the first area to the second area of the building. In an embodiment, the fauna item 210 may be placed on one end of the conveying device 205 in the first area. The conveying device 205 is any mechanical handling equipment that is suitable for moving fauna items 210 from the first area (or position) to a second area (or position). Non-liming examples of conveyor devices include belt conveyors, chain conveyors, motorized drive roller (MDR) conveyors, slat conveyors, roller conveyors, and overhead conveyors. The conveying device 205 consist of a network of belts, rollers, or other mechanisms that move objects from one location to another within the warehouse. In an example, automated guided vehicles (AGVs) or robotic systems may be used for transferring the fauna items 210 from the first area to the second area. Alternatively, rather than using a mechanical conveying system, the conveying system 200 may comprise human employees that manually move fauna items 210 and/or containers from one area to another. The conveying device 205 may be designed with various routing options and is programmed to direct the fauna items 210 to specific destinations within the warehouse, such as packaging stations, quality control areas, or shipping docks. In an example, the second area may be one of a packaging station, a quality control area, or a shipping dock.

In addition to moving fauna items 210 from the first area to the second area, the conveying system 200 may include an apparatus (or device) configured for attaching a unique identifier 215 to a given fauna item 210 in the first area. Alternatively, a human employee may manually attach the unique identifier to the fauna item 210. The unique identifier 215 can include one or more of a barcode (i.e., data in a visual, machine-readable form), a quick response code, referred to as a QR code, an alphanumeric character, an alphanumeric string of characters, a tag, or any combination thereof. In other words, the unique identifier 215 is any suitable graphic, code, and/or symbol that can be scanned, sensed, or otherwise identified by a machine for identification of the fauna item 210. The unique identifier 215 is attached proximate the fauna item 210 via a sticker or tag adhered to or hanging from the fauna item 210 itself, or the pot or planter (i.e., container) in which the fauna item 210 is planted. In an embodiment, automated labeling systems are integrated with conveyor belts of the conveying device 205 to automatically apply labels or tags on the fauna items 210. The automated labeling system may have a tag dispenser to provide a label having the unique identifier 215, an applicator to paste the label on the fauna item 210 or the pot or planter, and a verification system to verify accurate tagging on the fauna item 210. The automated labeling systems are equipped with sensors or vision systems that detect the presence of the fauna items 210 on the conveying device 205. In another embodiment, the automated labelling system may receive a signal from a first sensor 220 indicating the presence of the fauna item 210 in the first area, and the labelling system may attach the label to the fauna item 210.

Referring to FIG. 2, the first sensor 220 positioned in the first area senses that the fauna item 210 is within a predetermined proximity of the first area and sends a first senor signal to one or more processing units of the system. The predetermined proximity may be, for example, when the fauna item 210 is within a range of 100 centimeters (cm) from the first sensor 220. In one embodiment, the first sensor 220 is a camera that scans the unique identifier 215 on the fauna item 210. In an embodiment, the camera is a specialized imaging device, such as a proximity camera or a depth-sensing camera, designed to capture depth information about objects in their field of view. Such cameras typically use depth-sensing technology to measure the distance between the camera and objects in its environment. The depth-sensing technology may include, but not limited to, Time-of-Flight (ToF), structured light, and stereoscopic vision technology. The accuracy and range of proximity cameras vary depending on the technology and specifications. Some cameras provide accurate depth information over short distances, and other cameras are capable of longer-range sensing.

In another embodiment, the first sensor 220 is a motion sensor that detects movement of the fauna item 210 into the first area. The motion sensor may include, but not limited to, passive infrared (PIR) sensors, ultrasonic sensors, tomographic motion sensors, microwave sensors, and dual technology sensors. After receiving the first sensor signal, indicative of the fauna item 210 within the predetermined proximity of the first area, from the first sensor 220, the one or more processing units, or processors, of the system send a conveyance signal to the conveying device 205, which acts to cause the conveying device 205 to move the fauna item 210 to the second area. For example, the one or more processing units, or the processors may send the conveyance signal to a control unit or an actuator of the conveying device 205 to move a chain conveyor or a belt conveyor in a direction from the first area towards the second area, such that the fauna item 210 placed on the conveying device 205 is moved to the second area.

A second sensor 225 positioned in the second area senses that the fauna item 210 is within a predetermined proximity of the second area. In one embodiment, the second sensor 225 is a camera that scans the unique identifier 215 on the fauna item 210. For example, the camera may be integrated into a scanner that scans the unique identifier 215 and records the information embedded in the unique identifier 214. The scanner may include a barcode scanner, a QR code scanner, a radio frequency identification, referred to as RFID scanner, or a magnetic stripe reader. In another embodiment, the second sensor 225 is a motion sensor that detects movement of the fauna item 210 into the second area. After receiving a second sensor signal from the second sensor 225, the one or more processing units, send a recording signal to a recording system 230 positioned in the second area. The recording signal activates the recording system 230 to start capturing visual content (e.g., images) of the fauna item 210 from multiple views and perspectives, including an image of the unique identifier 215 that is in attachment with the respective fauna item 210. The visual content may include images, graphics, videos, or animations, rather than text or voice communication. In another embodiment, the visual content may include photographs, infographics, charts, illustrations, diagrams, memes, GIFs, slideshows, and any other media that relies on visual representation to communicate a message or information. In an example, the visual content may include a height, a width and a length of the fauna item 210.

The recording system 230 includes multiple (e.g., four) cameras 235 arranged in the second area for capturing images or other visual content of the respective fauna item 210 (i.e., data 240) from a plurality of perspectives. In an example, the second area may have additional light sources positioned around the second area to provide sufficient illumination for capturing high-quality clear images of the fauna item 210. Images may be captured sequentially or all at the same time from cameras 235 arranged at different locations in the second area. In an example, the images may be combined from the multiple cameras 235 to obtain higher-resolution images by fusing complementary information, such as color, texture, and depth, resulting in a more comprehensive representation. In another example, the multiple cameras 235 arranged around the fauna item 210 capture images to cover a complete 360-degree view of the fauna item 210. In addition, a short video of the fauna item 210 including views from different perspectives may also be captured. In the present embodiment, the recording system 230 includes four cameras 235. However, it is understood that a greater number of cameras arranged around the fauna item 210 to capture additional views, such as a top view, may also be within the spirit and scope of the present invention.

The data 240 including the images, videos and related information regarding the fauna item 210 and the pot is sent to the system 100, and the consumer device user 140 retrieves and displays the data 240 by accessing a webpage via his or her device 110. The consumer device user 140 can then select and purchase the fauna item 210 via the webpage, and the fauna item 210 will be shipped to the consumer device user 140. In addition, the consumer device user 140 can select a container 245 (e.g., pot, planter) configured to receive the selected fauna item 210.

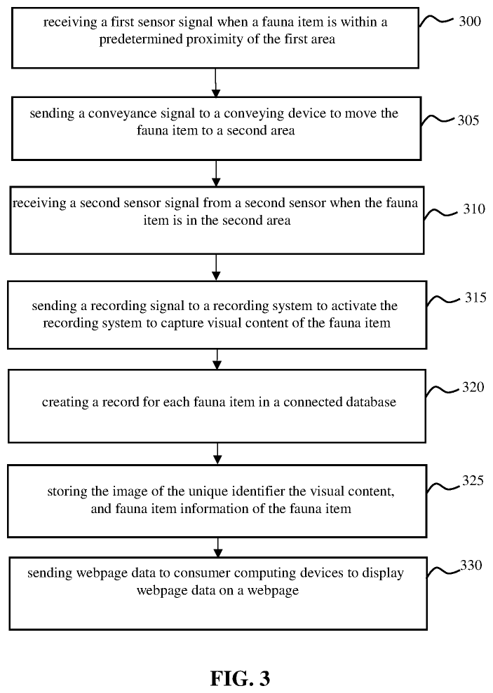

FIG. 3 is a flow diagram illustrating a method for conducting horticultural business via a communications network, specifically inventorying, and displaying fauna items. As described above, in a first step 300 of the process, a first sensor signal is received from a first sensor, such as the first sensor 220, when the fauna item is within a predetermined proximity of the first area. The first area may be, for example, a receiving dock in a warehouse where the fauna items are received and checked for any discrepancy or tampering. As described above, the first sensor may be a camera, such as a proximity camera or a depth-sensing camera. In another embodiment, the first sensor may be a motion sensor including PIR sensors, ultrasonic sensors, tomographic motion sensors, microwave sensors, and dual technology sensors, as described above.

In a second step 305, a conveyance signal is sent to a conveying device to cause the conveying device to move the fauna item from the first area to the second area via the conveying system. In an example, the conveyance signal is sent after receiving the first sensor signal. The fauna item is moved from the first area to the second area after receiving the sensor signal. For example, the conveying system 200 receives the first sensor signal from the first sensor 220 that the fauna item 210 is in the first area and the conveying device 205 moves the fauna item from the first area to the second area. In an embodiment, the fauna item comprises one of a plant, a tree, a shrub, a flower, a bush. In a third step 310, a second sensor signal is received from a second sensor that the fauna item is in the second area. After the fauna item reaches the second area, the second sensor 225 detects the presence of the fauna item indicating that the fauna item has moved from the first area to the second area.

In a fourth step 315, a recording signal is sent to a recording system after receiving the second sensor signal to activate the recording system to capture visual content of the fauna item from a plurality of perspectives. In other words, the sensing of the fauna item in the second area triggers capturing visual content of the fauna item and a unique identifier of the fauna item. The visual content of the respective fauna item may be captured from multiple perspectives, for example by the multiple cameras 235 and may include width, height, and length of the respective fauna item. The multiple cameras 235 of the recording system 230 are positioned around the fauna item in the second area to capture multiple images or a video of the fauna item from different angles. In an embodiment, the visual content also includes an image of the unique identifier, such as the unique identifier 215 that is attached to the respective fauna item. The unique identifier may include one of a quick response code (QR) code, an alphanumeric character, an alphanumeric string of characters, and a tag.

In a fifth step 320, a record for each fauna item is created and stored in the connected database. The record may be stored with a record identifier linked to the type of the fauna item such that the record identifier may be later used for easy retrieval and fetching of information from the connected database. In a sixth step 325, each fauna item record is stored with the image of the unique identifier for the fauna item, the visual content (e.g., image) for the fauna item, and any other data associated with the fauna item, referred to as fauna item information. The fauna item information may include one of a detailed description of the respective fauna item, such as care details, dimensions of the fauna item, and a detailed physical description of the fauna item, and a cost of the respective fauna item. In a seventh step 330, webpage data is sent to a transceiver of consumer computing devices to display the webpage data on a webpage. The webpage data is sent over the communications network, depicted in FIG. 1, to a transceiver of each of a plurality of consumer computing devices each associated with a consumer. The webpage data includes data for displaying (a) the image of the unique identifier for the respective fauna item, (b) the visual content for the respective fauna item, (c) and the plurality of fauna item information of the respective fauna item.

In an embodiment, after sending the webpage data, a fauna selection data associated with a selected fauna item is received over the communications network. The fauna selection data is received from the transceiver of a respective consumer computing device. The fauna selection data may be the particular fauna item, such as the fauna item 210, selected by the consumer for purchase consumer and the unique identifier associated with the selected fauna item. After receiving the fauna selection data, a plurality of container data corresponding to the selected fauna item is determined. The container data comprises data for displaying a container on the respective consumer computing device, where the container is configured to receive the selected fauna item. The plurality of container data is sent to a transceiver of the respective consumer device over the communications network. The system then receives from the transceiver of the consumer device a container selection data associated with a selected container for the selected fauna item. The container selection data may include information associated with the selected container for purchase by the consumer. The container selection data is stored in the connected database in a consumer record.

In an embodiment, after storing the container selection data, consumer area spatial data associated with a consumer area where at least one of a selected fauna item and a selected container are to be positioned, is received. In an example, the consumer area spatial data is received over the communications network. The consumer area spatial data includes a plurality of dimensions associated with the consumer area where at least one of the selected fauna item and the selected container are to be positioned. In an example, the consumer area includes an office or home environment of the consumer where the consumer intends to place the fauna item. After receiving the consumer area spatial data, a plurality of augmented reality data corresponding to the selected fauna item and the selected container disposed in the consumer area is determined. In an example, the augmented reality data includes data for displaying, on the respective consumer computing device, the selected fauna item and the selected container graphically disposed in the consumer area. In an embodiment, after determining the augmented reality data, the plurality of augmented reality data is sent to the transceiver of the respective consumer device for displaying on the respective consumer device. The augmented reality data displays, on the respective consumer device, the selected fauna item and the selected container graphically disposed in the consumer area. It is understood that the terms “consumer device” and “consumer computing device” may be used interchangeably throughout this application.

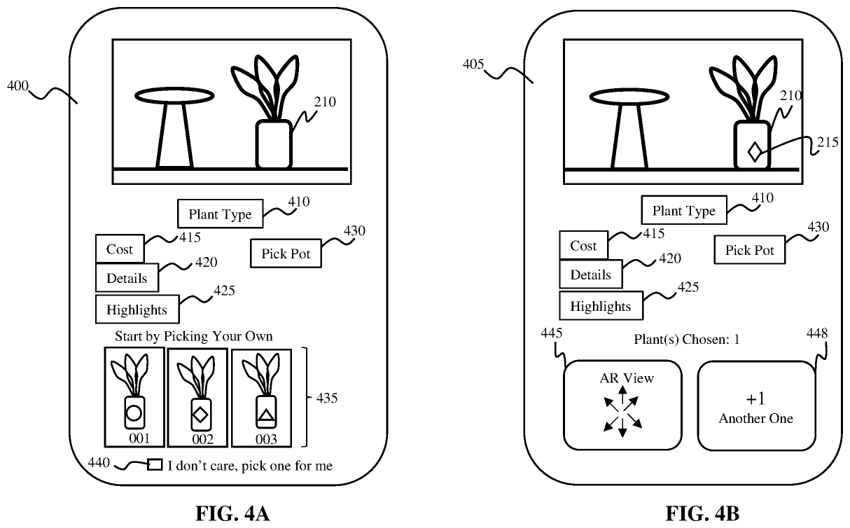

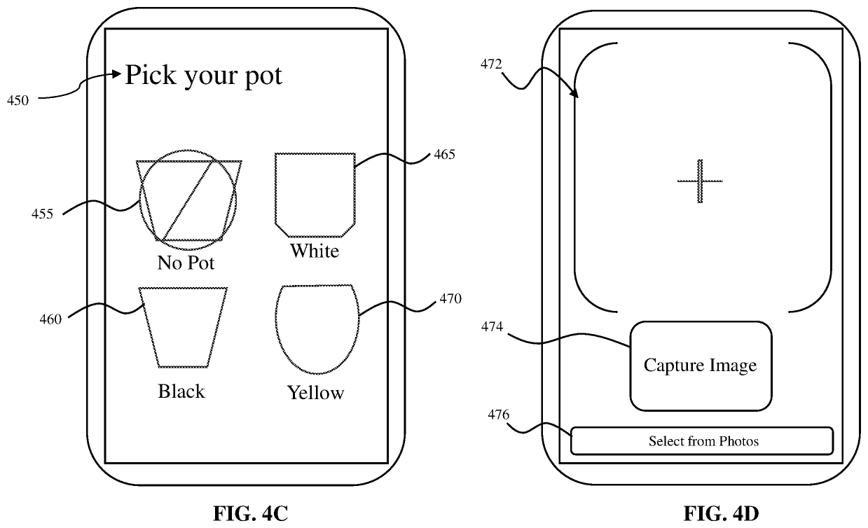

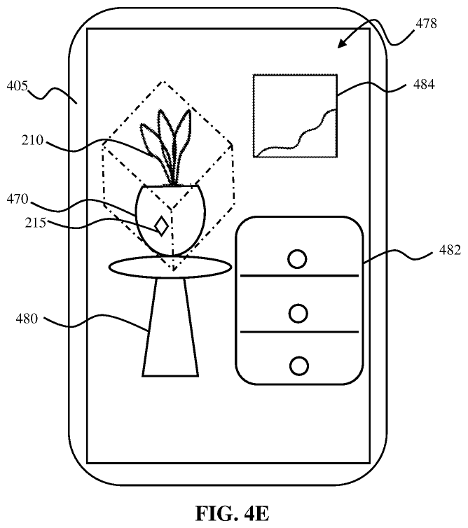

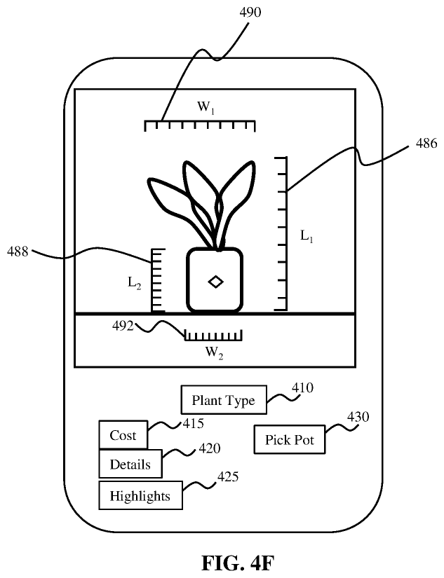

FIG. 4A and FIG. 4B depict non-limiting examples of graphical user interfaces (GUIs) 400 and 405 of the webpage data displayed on consumer devices. In one embodiment, shown in FIG. 4A, the GUI 400 includes graphical icons 410, 415, 420, and 425. Additionally, the GUIs 400 and 405 may include a graphical icon 430 for selecting a type (e.g., color, size, shape) of pot or planter. Non-limiting examples of graphical icons that can be displayed on GUIs 400 and 405 include plant type (e.g., large fiddle leaf bush), cost, details, and highlights. A “Details” graphical icon 420 can be displayed on the GUIs 400 and 405 include information regarding place of origin or natural habitat of a plant, sensitivity and tolerance to varying conditions, required soil conditions and how tall or large the plant may grow under a controlled setting (e.g., height, width, length). For example, the “Details” graphical icon 420 displays information that the large fiddle leaf bush is native to western Africa, the required soil conditions should have optimum moisture and should not be too dry nor too wet, and the air should not be too dry. Further, the “Details” graphical icon 420 displays that the large fiddle leaf bush can grow up to 4 or 5 feet tall and expanding to 2 to 3 feet wide. Non-limiting examples of a “highlights” graphical icon 425 that can be displayed on the GUIs 400 and 405 include important details regarding the fauna item, such as keeping the fauna item in direct or indirect sunlight, watering frequency, pet friendly characteristics, and ratio of balanced fertilizer. In the embodiment depicted in FIG. 4A, a group of images 435 of fauna items of the same type but having different unique identifiers is displayed. The group of images 435 allows a consumer to scroll through options of a specific fauna item before selecting the one that fits their particular needs. In an example, the group of images 435 show different views of the same fauna item 210 such that the consumer can view the fauna item from different perspectives and angles before selecting the fauna item. Alternatively, a consumer can select an option 440 that provides for automatic selection of the fauna item for the consumer.

As depicted in FIG. 4B, an embodiment of the GUI 405 displays the graphical icon 430 for selecting a type of pot or planter. The consumer selects the graphical icon 430 and multiple pots and planters are displayed on the GUI 405, as shown in FIG. 4C. A prompt 450 is displayed on the GUI 405 of the consumer device along with options in the form of icons on the interface when the customer intends to select and add a pot to a cart for purchase. A selected pot is shipped to the customer along with the fauna item 210 and the fauna item 210 is planted in the selected pot when delivered to the customer. For example, the prompt “Pick your pot” is displayed on the GUI 405 along with an option 455 representing a “no pot” icon, an option 460 representing a “black pot” icon, an option 465 with a “white pot” option, and an option 470 representing a “yellow pot” option. In the present embodiment the prompt is “Pick your pot”. However, other prompts requiring a response from the consumer may also be within the spirit and scope of the present invention.

As shown in FIG. 4C, the consumer may select any one of the displayed options of the colored pots and the selected pot is delivered to the consumer with selected fauna item 210. The displayed options 455, 460, 465, 470 also differ in shape and size of the pots. For example, the option 460 representing the black pot is of a triangular shape, the option 465 representing the white pot is rectangular shaped and the option 470 representing the yellow pot is curved shape. The size and dimensions of each pot is displayed when the user selects an option from the options 455, 460, 465, 470. In the present embodiment the options 455, 460, 465, 470 are displayed to be in a particular color, it is understood that each type of pot in these options 455, 460, 465, 470 are available in different colors, such as, but not limited to, white, black and yellow. The customer may select the option 455 representing the no pot option when the customer does not intent to purchase the pot. In this case, the fauna item 210 selected by the customer is delivered to the customer.

Referring to FIG. 4B, in one embodiment of the GUI 405 includes an augmented reality system 445. As understood by one skilled in the art, the augmented reality system 445 incorporates a combination of real and virtual objects in an accurate three-dimensional (3D) registration of the objects. The augmented reality system 445 allows a consumer to capture an image of an environment (e.g., home, office) in which the consumer would like to position a purchased fauna item. Further, the GUI 405 includes a graphical icon 448 representing “+1 Another one” that provides an option to the consumer to add another fauna item and a pot to the cart for purchase.

FIG. 4D shows an embodiment when the consumer selects the augmented reality system 445, a camera of the mobile device, such as the mobile devices 110, 115, 120, and 125, is activated and a field of view window of the camera is displayed on the GUI 405 of the mobile device. For example, a field of view 472 is displayed on the GUI 405, as shown in FIG. 4D. The consumer may adjust the field of view 472 of the camera to focus on the environment of the home or office to capture an image. The consumer may zoom in or zoom out as required and may focus on a particular object within the office or home environment to capture the image. For example, the consumer may capture the image of the office environment 478 as shown in FIG. 4E and the office environment 478 includes, a table 480, a drawer 482, and a wall hanging picture 484. The consumer may focus on a table, such as the table 480 of the office environment where the fauna item 210 is to be positioned or on a drawer, such as the drawer 482 in the office environment 478 for capturing the image.

The consumer may select an icon 474 representing “capture image” to capture the image within the field of view 472 on the GUI 405. Alternatively, the consumer may select an option 476 representing “select from photos”, when the consumer intends to select a stored image of the office or home saved in a local folder of the mobile device. The image of the office and home may be saved in the memory of the consumer device or may be accessed and retrieved from a local database that stores images and other multimedia files for the consumer device.

The consumer uploads the image to the webpage via the communication network 105, displays the image on the webpage, and selects a fauna item to visualize in their environment. The augmented reality system 445, in combination with the unique identifier 215 of the fauna item, allows the consumer to select a fauna item 210 on the webpage, view it in its intended environment, and purchase the selected fauna item having the corresponding unique identifier 215.

As shown in FIG. 4E, the augmented reality system 445 shows the combination of the fauna item 210 having the unique identifier 215 and the selected yellow pot 470 in the office environment 478. For example, FIG. 4E shows the fauna item 210 planted in the yellow pot 470 and positioned on the table 480.

In another embodiment, the consumer may select the “Details” graphical icon 420 for size and dimension of the fauna item 210. The fauna item 210 is displayed along with a scale representation to show the exact size and dimension of the fauna item 210, as depicted in FIG. 4F. For example, the scale is displayed next to the fauna item 210 to show a height of the fauna item 210. A scale 486 represents length L₁ of the fauna item 210 and a scale 488 represents length L₂ of the pot, such as the pot 470 is displayed along with the fauna item 210. FIG. 4F shows a scale 490 that represents a width or a spread W₁ of the fauna item 210, and a scale 492 that represents width W₂ of the pot 470. In an example, the dimensions L₁, L₂, W₁ and W₂ represent numerical values that indicate the exact dimensions of the fauna item 210 and the pot 470. In an embodiment, the visual content may include the dimensions, such as the width, the height and the length of the fauna item 210. Such dimensions provide a clear picture of the overall size of the fauna item 210 and the pot 470. Dimensions and size information helps consumers form accurate expectations about the item's physical size and proportions and reduces the likelihood of dissatisfaction upon receiving the item. Further, the dimensions and size information allow consumers to plan how the item would fit within their living space or office environment thereby preventing issues with space constraints and aesthetics.

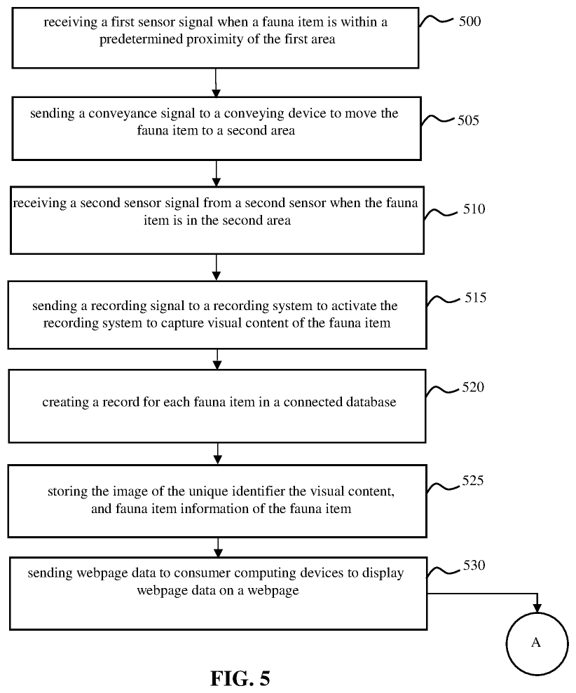

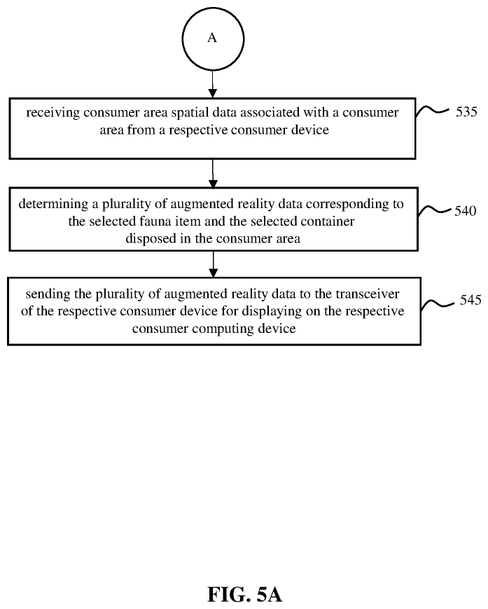

FIGS. 5 through 5A are a flow diagram illustrating a method for conducting horticultural business via a communications network, specifically inventorying, and displaying fauna items, in accordance with another embodiment. As described above, in a first step 500 of the process, a first sensor signal is received from a first sensor, such as the first sensor 220, when the fauna item is within a predetermined proximity of the first area. In a second step 505, a conveyance signal is sent to a conveying device to cause the conveying device to move the fauna item from the first area to the second area via the conveying system, such as the conveying system 200. In a third step 510, a second sensor signal is received from a second sensor that the fauna item is in the second area. For example, after the fauna item reaches the second area, the second sensor 225 detects the presence of the fauna item 210 indicating that the fauna item 210 has moved from the first area to the second area. In a fourth step 515, a recording signal is sent to a recording system after receiving the sensor signal to activate the recording system to capture visual content of the fauna item from a plurality of perspectives. For example, the one or more processors of the system send the recording signal to the recording system 230 such that the multiple cameras 235 capture images of the fauna item 210 from different perspectives.

In a fifth step 520, a record for each fauna item is created and stored in the connected database. In a sixth step 525, each fauna item record is stored with the image of the unique identifier for the fauna item, the visual content (e.g., image) for the fauna item, and fauna item information. The fauna item information may include one of a detailed description of the respective fauna item, such as care details, dimensions of the fauna item, and a detailed physical description of the fauna item, and a cost of the respective fauna item. In a seventh step 530, webpage data is sent to a transceiver of consumer computing devices to display the webpage data on a webpage over the communications network, shown in FIG. 1. As described above, the webpage data includes data for displaying (a) the image of the unique identifier for the respective fauna item, (b) the visual content for the respective fauna item, (c) and the plurality of fauna item information of the respective fauna item.

In an eighth step 535, consumer area spatial data associated with a consumer area where at least one of a selected fauna item and a selected container are to be positioned, is received over the communications network. The consumer area spatial data includes a plurality of dimensions associated with the consumer area, such as the office or home environment, where at least one of the selected fauna item and the selected container are to be positioned. In a ninth step 540, a plurality of augmented reality data corresponding to the selected fauna item and the selected container disposed in the consumer area is determined. The augmented reality data includes data for displaying, on the respective consumer computing device, the selected fauna item and the selected container graphically disposed in the consumer area. In a tenth step 545, the plurality of augmented reality data is sent to the transceiver of the respective consumer device for displaying on the respective consumer device. The augmented reality data displays the selected fauna item and the selected container graphically disposed in the consumer area.

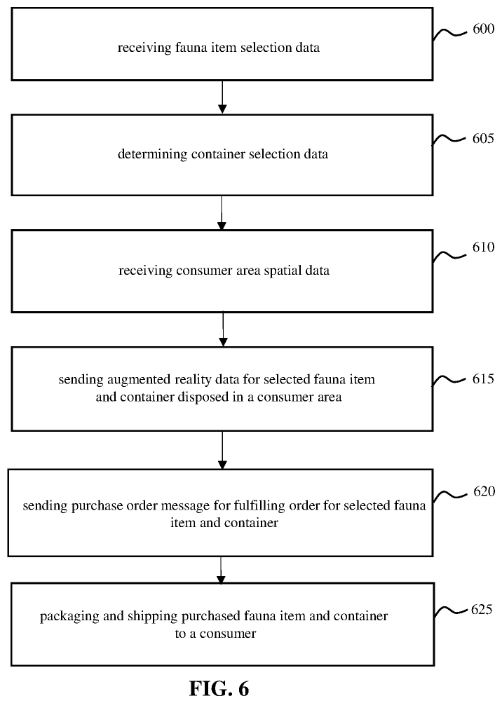

FIG. 6 is a flow diagram illustrating a method for selection and order fulfillment of fauna items, as described above. The fauna item includes a plant, a tree, a shrub, a flower, and a bush. In a first step 600, fauna item selection data is received by one or more processors of the system described herein. The fauna item selection data is received over a communications network, such as the communications network 105 from the transceiver of a respective consumer computing device. The fauna selection data includes information related to the selected fauna item for purchase by the consumer and the unique identifier associated with the selected fauna item. In an example, fauna item information is associated with the respective fauna item includes a detailed description of the respective fauna item and a cost of the respective fauna item.

After receiving fauna selection data associated with the selected fauna item, a plurality of container (e.g., pot, planter) data corresponding to the selected fauna item are determined in a second step 605. The container data may include size, such as height, weight, diameter, color, shape, weight and material of a pot or a planter. The container data is sent, over the communications network 105, to a transceiver of a consumer computing device and stored in a connected database in a consumer record.

In a third step 610 utilizing the augmented reality system described herein, consumer area spatial data associated with the area where the selected fauna item and selected container (e.g., pot, planter) is to be positioned in the consumer's home or office is received. In a fourth step 615, the consumer area spatial data is transmitted over the communications network 105 from the transceiver of a respective consumer computing device (e.g., smartphone, laptop). The consumer area spatial data includes a plurality of dimensions (e.g., area of a room, length/height of a table) associated with the consumer area. After receiving the consumer area spatial data, a plurality of augmented reality data corresponding to the selected fauna item and selected container disposed in the consumer area are determined. As understood by one skilled in the art, feature detection methods, such as corner detection, blob detection, and edge detection, as well as other image processing methods are used to generate the augmented reality data. The augmented reality data is sent over the communications network 105 to the transceiver of a respective consumer computing device. The augmented reality data, including graphical displays of the selected fauna item and selected container disposed in the consumer area, is displayed to the consumer via the respective consumer computing device.

After the consumer selects a specific fauna item and a specific container, the system described herein sends a purchase order message to an operator computing device to fulfill a purchase order for the selected fauna item and selected container in a fifth step 620. Based on the purchase order message, the selected fauna item, as identified by the unique identifier, and selected container is packaged for shipping and delivery to the consumer in a sixth step 625.

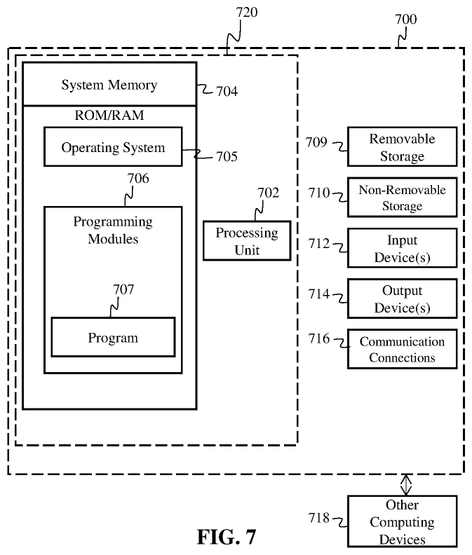

FIG. 7 is a block diagram of a computer system for conducting horticultural business via a communications network. FIG. 7 depicts an example computing device 700 and other computing devices. Consistent with the embodiments described herein, the aforementioned actions performed by system 100 may be implemented in a computing device, such as the computing device 700 of FIG. 7. Any suitable combination of hardware, software, or firmware may be used to implement the computing device 700. The aforementioned system, device, and processors are examples and other systems, devices, and processors may comprise the aforementioned computing device. Furthermore, computing device 700 may comprise an operating environment for system 100. Processes, data related to system 100 may operate in other environments and are not limited to computing device 700.

A system consistent with an embodiment of the invention may include a plurality of computing devices, such as computing device 700. In a basic configuration, computing device 700 may include at least one processing unit 702 and a system memory 704. Depending on the configuration and type of computing device, system memory 704 may comprise, but is not limited to, volatile (e.g., random access memory (RAM)), non-volatile (e.g., read-only memory (ROM)), flash memory, or any combination or memory. System memory 704 may include operating system 705, and one or more programming modules 706. Operating system 705, for example, may be suitable for controlling computing device 700's operation. In one embodiment, programming modules 706 may include, for example, a program module 707 for executing the actions of system 100 for example. Furthermore, embodiments of the invention may be practiced in conjunction with a graphics library, other operating systems, or any other application program and is not limited to any particular application or system. This basic configuration is illustrated in FIG. 7 by those components within a dashed line 720.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable, and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 700. Any such computer storage media may be part of computing device 700. Computing device 700 may also have input device(s) 712 such as a keyboard, a mouse, a pen, a sound input device, a camera, a touch input device, etc. Output device(s) 714 such as a display, speakers, a printer, etc. may also be included. The aforementioned devices are only examples, and other devices may be added or substituted.

Computing device 700 may also contain a communication connection 716 that may allow system 100 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 704, including operating system 705. While executing on processing unit 702, programming modules 706 (e.g., program module 607) may perform processes including, for example, one or more of the stages of a process. The aforementioned processes are examples, and processing unit 702 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for inventorying, displaying, monitoring and selection of a plurality of fauna items comprising:
a conveying system for moving a respective fauna item from a first area to a second area;
wherein the conveying system is configured for attaching a unique identifier at least proximate to the respective fauna item at the first area;
a recording system positioned at the second area, wherein the recording system includes a plurality of cameras arranged for capturing images or visual content of the respective fauna item from a plurality of perspectives;
a connected database; and
a processor configured for:
i. receiving a first sensor signal from a first sensor indicating that the respective fauna item is within a predetermined proximity of the first area;
ii. after receiving the first sensor signal, sending a conveyance signal to the conveying system causing the conveying system to move the respective fauna item from the first area to the second area;
iii. receiving a second sensor signal from a second sensor that the respective fauna item is in the second area;
iv. sending a recording signal to the recording system to activate the recording system to capture visual content of the respective fauna item from the plurality of perspectives, including an image of the unique identifier;
v. creating, in the connected database, a fauna item record for each of the plurality of fauna items;
vi. storing, in each respective fauna item record, (a) the image of the unique identifier for the respective fauna item, (b) the visual content for the respective fauna item, (c) a plurality of fauna item information of the respective fauna item; and
vii. sending, over a communications network, to a transceiver of a plurality of consumer computing devices each associated with a consumer, webpage data to display on a webpage on a plurality of consumer computing devices, wherein the webpage data includes data for displaying (a) the image of the unique identifier for the respective fauna item, (b) the visual content for the respective fauna item, and (c) the plurality of fauna item information of the respective fauna item.

2. The system of claim 1, wherein the respective fauna item comprises at least one of a plant, a tree, a shrub, a flower, a bush.

3. The system of claim 1, wherein the unique identifier comprises at least one of a quick response code (QR) code, an alphanumeric character, an alphanumeric string of characters, and a tag.

4. The system of claim 1, wherein the plurality of fauna item information associated with the respective fauna item includes at least one of a detailed description of the respective fauna item and a cost of the respective fauna item.

5. The system of claim 1, wherein the visual content for the respective fauna item comprises at least one of a width, height, and length of the respective fauna item.

6. The system of claim 1, wherein the processor is further configured for:
receiving, over the communications network from the transceiver of a respective consumer computing device of the plurality of consumer computing devices, fauna selection data associated with a selected fauna item from one of the plurality of fauna items;
wherein the fauna selection data comprises information related to the selected fauna item for purchase by the consumer and the unique identifier associated with the selected fauna item;
after receiving the fauna selection data associated with the selected fauna item, determining a plurality of container data corresponding to the selected fauna item;
wherein the plurality of container data comprises data for displaying a container on the respective consumer computing device, where the container is configured to receive the selected fauna item;
sending, over the communications network to the transceiver of the respective consumer computing device, the plurality of container data corresponding to the selected fauna item;
receiving, over the communications network from the transceiver of the respective consumer computing device, container selection data associated with a selected container for the selected fauna item;
wherein the container selection data comprises information associated with the selected container for purchase by the consumer; and
after receiving the container selection data associated with the selected fauna item, storing in the connected database the container selection data in a consumer record.

7. The system of claim 6, wherein the processor is further configured for:
receiving, over the communications network from the transceiver of the respective consumer computing device, consumer area spatial data associated with a consumer area where the selected fauna item and the selected container are to be positioned;
wherein consumer area spatial data includes a plurality of dimensions associated with the consumer area where the selected fauna item and the selected container are to be positioned;
after receiving the consumer area spatial data, determining a plurality of augmented reality data corresponding to the selected fauna item and the selected container disposed in the consumer area;
wherein the plurality of augmented reality data includes data for displaying, on the respective consumer computing device, the selected fauna item and the selected container graphically disposed in the consumer area; and
sending, over the communications network to the transceiver of the respective consumer computing device, the plurality of augmented reality data for displaying on the respective consumer computing device the selected fauna item and the selected container graphically disposed in the consumer area.

8. The system of claim 1, wherein the processor is further configured for sending a purchase order message to an operator computing device to fulfill an order for the respective fauna item and selected container.

9. A method for inventorying, displaying, monitoring and selection of a plurality of fauna items comprising:
receiving a first sensor signal from a first sensor indicating that a respective fauna item is within a predetermined proximity of a first area;
after receiving the first sensor signal, sending a conveyance signal to a conveying device, causing the conveying device to move the respective fauna item from the first area to a second area;
receiving a second sensor signal from a second sensor that the respective fauna item is in the second area;
after receiving the second sensor signal, sending a recording signal to a recording system to activate the recording system to capture visual content of the respective fauna item from a plurality of perspectives, including an image of a unique identifier that is in attachment with the respective fauna item;
creating, in a connected database, a fauna item record for each of the plurality of fauna items;
storing, in each respective fauna item record, (a) the image of the unique identifier for the respective fauna item, (b) the visual content for the respective fauna item, (c) and a plurality of fauna item information of the respective fauna item; and
sending, over a communications network, to a transceiver of a plurality of consumer computing devices each associated with a consumer, webpage data to display on a webpage on consumer computing devices of consumers, wherein the webpage data includes data for displaying (a) the image of the unique identifier for the respective fauna item, (b) the visual content for the respective fauna item, (c) and the plurality of fauna item information of the respective fauna item.

10. The method of claim 9 further comprising:
receiving, over the communications network, from the transceiver of a respective consumer computing device of the plurality of consumer computing devices, fauna selection data associated with a selected fauna item from one of the plurality of fauna items;
wherein the fauna selection data comprises information related to the selected fauna item for purchase by the consumer and the unique identifier associated with the selected fauna item;
after receiving the fauna selection data associated with the selected fauna item, determining a plurality of container data corresponding to the selected fauna item;
wherein the plurality of container data comprises data for displaying a container on the respective consumer computing device, where the container is configured to receive the selected fauna item;
sending, over the communications network to the transceiver of the respective consumer computing device, the plurality of container data corresponding to the selected fauna item;
receiving, over the communications network from the transceiver from the respective consumer computing device, container selection data associated with a selected container for the selected fauna item;
wherein the container selection data comprises information associated with the selected container for purchase by the consumer; and
after receiving the container selection data associated with the selected fauna item, storing in the connected database the container selection data in a consumer record.

11. The method of claim 10 further comprising:
receiving, over the communications network from the transceiver from the respective consumer computing device, consumer area spatial data associated with a consumer area where the selected fauna item and the selected container are to be positioned;
wherein consumer area spatial data includes a plurality of dimensions associated with the consumer area where the selected fauna item and the selected container are to be positioned;
after receiving the consumer area spatial data, determining a plurality of augmented reality data corresponding to the selected fauna item and the selected container disposed in the consumer area;
wherein the plurality of augmented reality data includes data for displaying, on the respective consumer computing device, the selected fauna item and the selected container graphically disposed in the consumer area; and
sending, over the communications network to the transceiver of the respective consumer computing device, the plurality of augmented reality data for displaying on the respective consumer computing device the selected fauna item and the selected container graphically disposed in the consumer area.

12. The method of claim 11, wherein the respective fauna item comprises at least one of a plant, a tree, a shrub, a flower, a bush.

13. The method of claim 12, wherein the unique identifier comprises at least one of a quick response code (QR) code, an alphanumeric character, an alphanumeric string of characters, and a tag.

14. The method of claim 13, wherein the plurality of fauna item information associated with the respective fauna item includes at least one of a detailed description of the respective fauna item and a cost of the respective fauna item.

15. The method of claim 14, wherein the visual content for the respective fauna item comprises at least one of a width, a height, and a length of the respective fauna item.

16. A method for inventorying, displaying, monitoring and selection of a plurality of fauna items comprising:
receiving a first sensor signal from a first sensor indicating that a respective fauna item is within a predetermined proximity of a first area;
after receiving the first sensor signal, sending a conveyance signal to a conveying device, causing the conveying device to move the respective fauna item from the first area to a second area;
receiving a second sensor signal from a second sensor that the respective fauna item is in the second area;
after receiving the second sensor signal, sending a recording signal to a recording system to activate the recording system to capture visual content of the respective fauna item from a plurality of perspectives, including an image of a unique identifier that is in attachment with the respective fauna item;
creating, in a connected database, a fauna item record for each of the plurality of fauna items;
storing, in each respective fauna item record, (a) the image of the unique identifier for the respective fauna item, (b) the visual content for the respective fauna item, (c) and a plurality of fauna item information of the respective fauna item;
sending, over a communications network, to a transceiver of a plurality of consumer computing devices each associated with a consumer, webpage data to display on a webpage on consumer computing devices of consumers, wherein the webpage data includes data for displaying (a) the image of the unique identifier for the respective fauna item, (b) the visual content for the respective fauna item, (c) and the plurality of fauna item information of the respective fauna item;
receiving, over the communications network from the transceiver from a respective consumer computing device, consumer area spatial data associated with a consumer area where at least one of a selected fauna item and a selected container are to be positioned;
wherein consumer area spatial data includes a plurality of dimensions associated with the consumer area where at least one of the selected fauna item and the selected container are to be positioned;
after receiving the consumer area spatial data, determining a plurality of augmented reality data corresponding to the selected fauna item and the selected container disposed in the consumer area;
wherein the plurality of augmented reality data includes data for displaying, on the respective consumer computing device, the selected fauna item and the selected container graphically disposed in the consumer area; and
sending, over the communications network to the transceiver of the respective consumer computing device, the plurality of augmented reality data for displaying on the respective consumer computing device the selected fauna item and the selected container graphically disposed in the consumer area.

17. The method of claim 16 further comprising:
receiving, over the communications network from the transceiver of a respective consumer computing device of the plurality of consumer computing devices, fauna selection data associated with the selected fauna item from one of the plurality of fauna items;
wherein the fauna selection data comprises information related to the selected fauna item for purchase by the consumer and the unique identifier associated with the selected fauna item;
after receiving the fauna selection data associated with the selected fauna item, determining a plurality of container data corresponding to the selected fauna item;
wherein the plurality of container data comprises data for displaying a container on the respective consumer computing device, where the container is configured to receive the selected fauna item;
sending, over the communications network to the transceiver of the respective consumer computing device, the plurality of container data corresponding to the selected fauna item;
receiving, over the communications network from the transceiver from the respective consumer computing device, container selection data associated with the selected container for the selected fauna item;
wherein the container selection data comprises information associated with the selected container for purchase by the consumer; and
after receiving the container selection data associated with the selected fauna item, storing in the connected database the container selection data in a consumer record.

18. The method of claim 16, wherein the plurality of fauna item information associated with the respective fauna item includes at least one of a detailed description of the respective fauna item and a cost of the respective fauna item.

19. The method of claim 16, wherein the visual content for the respective fauna item comprises at least one of a width, height, and length of the respective fauna item.

20. The method of claim 16, wherein the respective fauna item comprises at least one of a plant, a tree, a shrub, a flower, a bush and wherein the unique identifier comprises at least one of a quick response code (QR) code, an alphanumeric character, an alphanumeric string of characters, and a tag.
